(19) United States
(12) Patent Application Publication
(10) Pub. No.: US 2026/0304573 A1
(43) Pub. Date: Oct. 1, 2026

(54) CIRCUIT FOR DRIVING AN LED STRING

(71) Applicant: AMS-OSRAM AG, Premstaetten (AT)

(72) Inventors: Carlo FIOCCHI, Belgioioso (PV) (IT); Salvador Enrique HOSTALET LEITZKE, Valencia (ES)

(21) Appl. No.: 19/474,740

(22) PCT Filed: May 14, 2024
(86) PCT No.: PCT/EP2024/063274

§ 371 Date: Oct. 13, 2025

(30) Foreign Application Priority Data
May 31, 2023 (DE) 10 2023 114 302.6

(51) Int. Cl. H05B 45/48; H05B 45/397

(52) U.S. Cl. CPC H05B 45/48; H05B 45/397

(57) ABSTRACT

A driving circuit for driving a light-emitting diode, LED, string including a first LED and plurality of further LEDs coupled in series. The driving circuit includes a current comparator, the current comparator being configured to compare a supply current dependent on a supply voltage supplied by a voltage source with a reference current, and to generate a difference current. The driving circuit further includes a control element for controlling a current steered into one of the further LEDs. The control element includes a bypass element coupled in parallel to the further LED, the bypass element being controlled in dependence from the difference current.

### CROSS-REFERENCE TO RELATED APPLICATIONS

This application is a national phase of International Application No. PCT/EP2024/063274 filed on May 14, 2024, which claims priority to German Patent Application No. 10 2023 114 302.6, which was filed on May 31, 2023, the entire contents of both of which are incorporated herein by reference.

### FIELD

The present disclosure relates to a circuit for driving an LED string.

### BACKGROUND

Light-emitting diode (LED) strings comprise a plurality of LEDs which are connected in series. For example, an LED string is driven using a battery. Usually, at low battery voltages, some of the LEDs may be switched off. Attempts are being made to develop driving circuits which enable a smooth transition depending on the battery status.

### SUMMARY

It is an object of the present invention to provide an improved circuit for driving an LED string.

According to embodiments, the above object is achieved by the claimed matter according to the independent claims. Further developments are defined in the dependent claims.

Embodiments relate to a driving circuit for driving a light-emitting diode, LED, string comprising a first LED and plurality of further LEDs coupled in series. The circuit comprises a current comparator, the current comparator being configured to compare a supply current dependent on a supply voltage supplied by a voltage source with a reference current, and to generate a difference current. The driving circuit further comprises a control element for controlling a current steered into one of the further LEDs. The control element comprises a bypass element coupled in parallel to the further LED, the bypass element being controlled in dependence from the difference current.

The driving circuit may further comprise a converter to generate the supply current as a function of the supply voltage.

For example, the bypass element may comprise a bypass current mirror.

According to embodiments, the control element comprises a variable transistor having a variable gain, the transistor being configured to deliver an adjustable supply current.

For example, the control circuit is configured to control the bypass element so that if the supply current is larger than the reference current, an LED current I_{led} is steered across the LED and if the supply current is smaller than the reference current, a current smaller than I_{led} is steered across the LED.

According to embodiments, the control element comprises a first current mirror configured to replicate a difference current of the reference current and the supply current into a diode-connected transistor of the bypass current mirror when the supply current is smaller than the reference current.

According to further embodiments, the control element may be configured to provide an overdrive current to the diode-connected transistor of the bypass current mirror when the supply current is smaller than the reference current.

For example, the control element may comprise a third current mirror configured to replicate a difference current, at a second node, of an overdrive current supplied by an overdrive current source and a difference between the supply current and the reference current into a diode-connected transistor of the bypass current mirror, when the supply current is larger than the reference current and smaller than the overdrive current.

The driving circuit may further comprise a boosting circuit configured to add a boosting current to the difference current at the second node, when the supply current is smaller than the reference current.

By way of example, the driving circuit may further comprise a second current mirror configured to replicate the difference current to the second node.

According to embodiments, a gain of the second current mirror may be adjustable.

For example, the driving circuit may further comprise further control elements, each of the further control elements being assigned to a corresponding one of the further LEDs.

For example, a reference current fed to the respective ones of the control elements may be individually adjustable.

For example, each of the control elements comprises a variable transistor having a variable gain, and the gain of the variable transistors of the respective control elements is individually adjustable.

According to embodiments, each of the control elements comprises a second current mirror having a variable gain. The gain of the second mirrors of the respective control elements may be individually adjustable.

According to embodiments, a driving circuit for driving a light-emitting diode, LED, string comprising a first LED and plurality of further LEDs coupled in series, comprises a current comparator. The current comparator is configured to compare a supply current dependent on a supply voltage supplied by a voltage source with a reference current, and to generate a difference current. The driving circuit further comprises a bypass element, and circuit elements for mirroring the difference current to the bypass element. The bypass element is configured to subtract a bypass current depending on the difference current from an LED current fed to a corresponding one of the further LEDs, the LED current depending on the supply current.

For example, the bypass element may be controlled so that if the supply current is larger than the reference current, the LED current I_{led} is steered across the LED and if the supply current is smaller than the reference current, a current smaller than I_{led} is steered across the LED.

### BRIEF DESCRIPTION OF THE DRAWINGS

The accompanying drawings are included to provide a further understanding of embodiments of the invention and are incorporated in and constitute a part of this specification. The drawings illustrate the embodiments of the present invention and together with the description serve to explain the principles. Other embodiments of the invention and many of the intended advantages will be readily appreciated, as they become better understood by reference to the following detailed description. The elements of the drawings are not necessarily to scale relative to each other. Like reference numbers designate corresponding similar parts.

FIG. 1 is a schematic drawing of a circuit for driving an LED string.

FIG. 2A is an equivalent circuit diagram of a driving circuit according to embodiments.

FIG. 2B is an equivalent circuit diagram of a driving circuit according to further embodiments.

FIG. 2C is an equivalent circuit diagram of a driving circuit according to further embodiments.

FIG. 2D is an equivalent circuit diagram of a driving circuit according to further embodiments.

FIG. 3 is a schematic drawing of a circuit for driving an LED string according to embodiments.

FIG. 4 shows an example of an I/V characteristics of a driving circuit.

### DETAILED DESCRIPTION

In the following detailed description reference is made to the accompanying drawings, which form a part hereof and in which are illustrated by way of illustration specific embodiments in which the invention may be practiced. In this regard, directional terminology such as “top”, “bottom”, “front”, “back”, “over”, “on”, “above”, “leading”, “trailing” etc. is used with reference to the orientation of the Figures being described. Since components of embodiments of the invention can be positioned in a number of different orientations, the directional terminology is used for purposes of illustration and is in no way limiting. It is to be understood that other embodiments may be utilized and structural or logical changes may be made without departing from the scope defined by the claims.

The description of the embodiments is not limiting. In particular, elements of the embodiments described hereinafter may be combined with elements of different embodiments.

Within the present disclosure, elements of an electrical circuit are described by referring to specific types of transistors, e.g. PMOS and NMOS transistors. As is to be clearly understood, the corresponding disclosure is not limiting. In particular, PMOS transistors may be replaced by NMOS transistor and vice versa while adapting the further circuitry where appropriate, as is generally known to the person skilled in the art. Further, where appropriate, illustrated NMOS and PMOS transistors may be replaced by further transistor types, e.g. bipolar transistors.

As employed in this specification, the terms “coupled” and/or “electrically coupled” are not meant to mean that the elements must be directly coupled together—intervening elements may be provided between the “coupled” or “electrically coupled” elements. The one or more intervening elements may be adapted for signal and/or power transmission. The one or more intervening elements may, for example, be controllable to temporarily provide a low-resistive connection in a first state and a high-resistive electric decoupling in a second state.

According to further embodiments and where appropriate, the term “electrically connected” may mean that the respective elements are “directly connected” or are “directly and permanently connected”.

The term “electrically connected” may describe a permanent low-resistive connection between electrically connected elements, for example a direct contact between the concerned elements or a low-resistive connection via a metal and/or heavily doped semiconductor material. The term “electrically connected” may describe a low-ohmic electric connection between the elements electrically connected together. An ohmic contact may be a non-rectifying electrical junction.

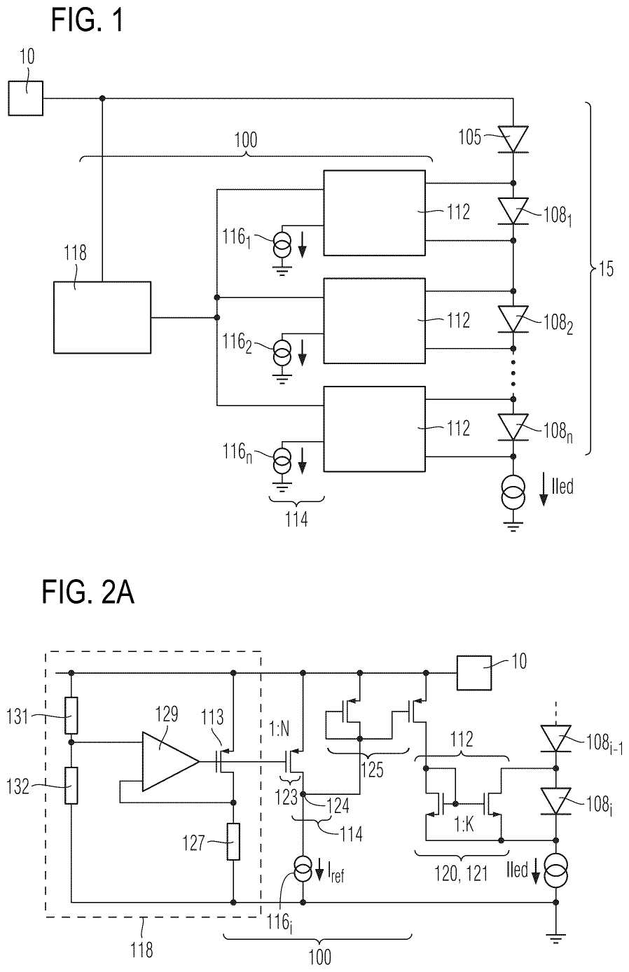

FIG. 1 schematically shows an LED string 15, a driving circuit 100 for driving the LED string 15 and a voltage source 10, e.g. a battery. For example, such an LED string 15 may be employed for automotive lighting. The LED string 15 comprises a first LED 105 and a plurality of further LEDS 108₁, 108₂, . . . 108ₙ that are coupled in series. The LED string is coupled to the voltage source 10, e.g. a battery. The term “battery” as used within the present disclosure is intended to mean a voltage source 10 that is configured to supply a voltage that may vary. For example, the supplied voltage may decrease during use and may increase after the battery has been charged. As is to be clearly understood, within the scope of the present disclosure, any other type of voltage source may be employed instead of a battery.

As is illustrated in FIG. 1, the driving circuit 100 comprises a plurality of control elements 112. Each of the control elements 112 is assigned to a corresponding one of the further LEDs 108ᵢ. As is indicated in FIG. 1, the control element 112 may be configured to bypass a corresponding one of the LEDS 108ᵢ. The driving circuit 100 may comprise a converter 118 that is configured to convert the voltage supplied by the voltage source 10 into a supply current that depends on the voltage supplied by the voltage source 10. The supply current may be fed to each of the control elements 112. Each of the control elements 112 may be configured to compare the supply current supplied by the converter 118 with a reference current I_{ref} that is supplied by a corresponding one of the reference current generators 116₁ . . . 116ₙ. Depending on a result of comparison, a current steered into each of (the LEDs 108₁, 108₂ . . . 108ₙ may be controlled. As is further illustrated in FIG. 1, the entire driving circuit 100 may comprise one single converter 118 and a plurality of control elements 112. For example, the number of the control elements 112 may correspond to the number of the further LEDs 108₁ . . . 108ₙ.

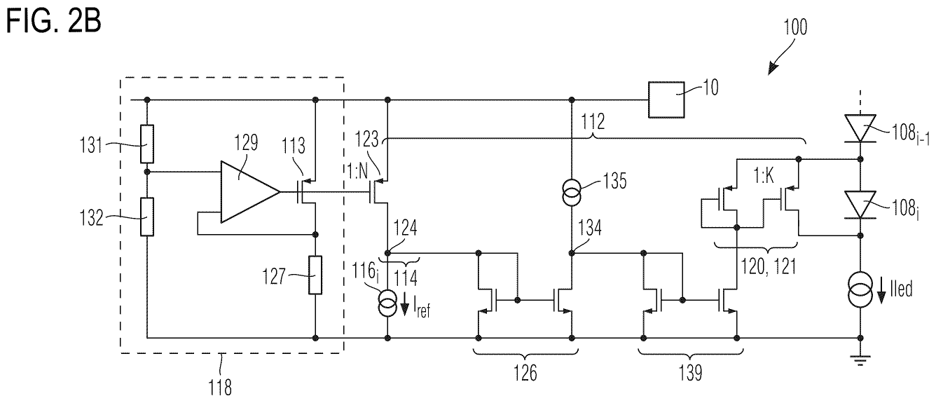

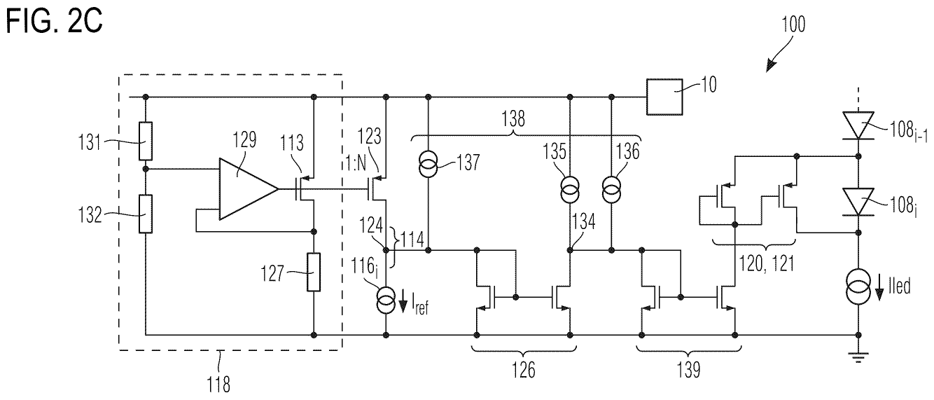

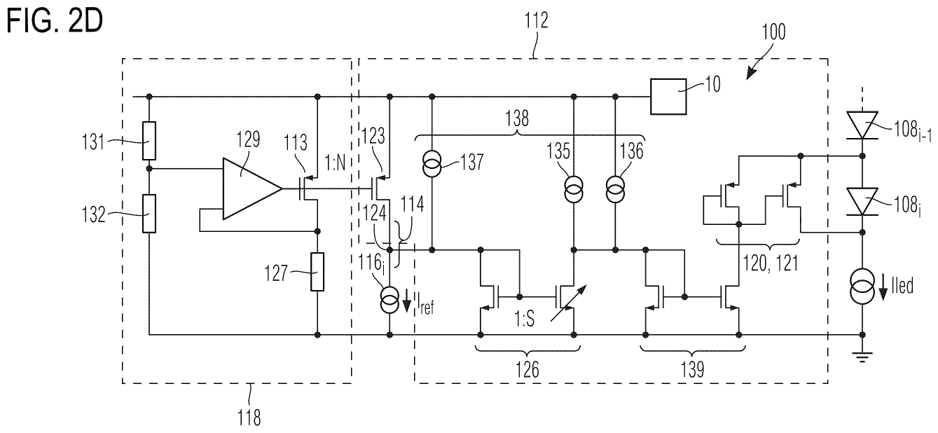

FIG. 2A shows an equivalent circuit diagram of a portion of the driving circuit 100. As is shown in FIG. 2A, a driving circuit 100 comprises a current comparator 114 which is configured to compare a supply current which is dependent on a supply voltage supplied by a voltage source with a reference current I_{ref} and to generate a difference current. The circuit 100 further comprises a control element 112 for controlling a current steered into one of the further LEDs 108ᵢ. The control element comprises a bypass element. The bypass element 120 comprises a bypass current mirror 121 which is coupled in parallel to the further LED 108ᵢ. The bypass current mirror 121 is controlled in dependence from the difference current. The bypass current mirror 121 may comprise a diode-connected transistor and a further transistor having a scaling ratio or gain K with respect to the diode-connected transistor.

For example, as is illustrated in FIG. 2A, the driving circuit 100 may further comprise a converter 118 which is configured to generate a supply current which depends on the supply voltage supplied by the voltage source 10. For example, the converter 118 may comprise a generating transistor 113, the gate electrode of which is coupled to an output of an amplifier 129. A drain terminal of the generating transistor 113 is coupled to a first converter node which is coupled to an input of the amplifier 129. Another input of the amplifier 129 is coupled to a second node which is coupled via a first resistor 131 to the voltage source 10. The drain terminal of the generating transistor 113 may be further connected via a resistor 127 to a third node. The third node is coupled via a second resistor 132 to the second node. The output of the amplifier 129 is further connected to a gate electrode of a variable transistor 123 which may have a scaling ratio or gain N with respect to the generating transistor 113. As a consequence, an output of the variable transistor 123 may have a value N×α×VBAT/R, wherein α denotes an attenuation factor caused by the voltage divider comprising the first and the second resistor 131, 132, and R denotes the resistance of resistor 127.

The current output by the variable transistor 123 is connected to a first node 124 which is also connected to a reference current generator 116ᵢ for generating a reference current I_{ref}. The first node 124 is also connected to a first current mirror 125. The first node 124 implements a comparator 114 which is configured to compare the supply current with the reference current.

For example, the first current mirror 125 may comprise two PMOS transistors. A drain terminal of the diode-connected transistor of the first current mirror 125 is coupled to the first node 124. A drain terminal of the non-diode-connected transistor of the first current mirror 125 may be coupled to a diode-connected transistor of the bypass current mirror 121. The bypass current mirror 121 may be coupled in parallel to the corresponding LED 108ᵢ.

When the supply current is larger than the reference current at node 124, the current I_{led} is fully steered into the LED 108ᵢ. When the supply current is less than I_{ref}, the difference between the reference current and the supply current is replicated by the first current mirror 125 into the diode-connected transistor of the bypass mirror 121. Accordingly, a current that is linear in dependence from the supply voltage is supplied to the bypass current mirror 121 and subtracted from the LED current I_{led}. When Iref is chosen to be larger than I_{led}/K and, in addition, the battery voltage is very low, the LED current is fully steered into the bypass element 120 and the LED is totally off.

Accordingly, simple mirror-based implementation supports the suppression of negative difference contributions when the supply voltage becomes very large. This may be due to the rectifying action of the first mirror 125. At the same time, the bypass current mirror 121 is crossed by a current that is linear in dependence from the supply voltage. Further, this arrangement makes the transition point of the LED current versus the supply voltage independent from the threshold of the bypass element 120. As a result, a superior performance with an even simpler structure may be obtained.

As is clearly to be understood, the elements of FIG. 2A may be applied to the configuration of FIG. 1. In more detail, the single elements implementing the control element 112 may be assigned to each of the single LEDs 108ᵢ. Moreover, one single converter 118 may be assigned to the entire driving circuit 100. For example, the values of N and the reference voltage supplied by the reference current generator 116ᵢ may be set individually for each of the LEDs 108ᵢ. According to embodiments illustrated in FIG. 2A, the selection of I_{ref} determines the supply voltage where the transition is fully completed and I_{led} is totally steered into the respective LED 108ᵢ. Further, by setting the gain N, the range of the supply voltage which is necessary to fully complete the transition may be set.

FIG. 2B is an equivalent circuit diagram of a driving circuit 100 according to further embodiments. As will be explained in the following, according to FIG. 2B, the control element 112 is further configured to provide an overdrive current to the diode-connected transistor of the bypass current mirror 121 when the supply current is smaller than the reference current.

In more detail, as is shown in FIG. 2B, the control element 112 may comprise a third current mirror 139. The third current mirror 139 is configured to replicate a difference current of an overdrive current which is supplied by an overdrive current source 135 and a difference between the supply current and the reference current, when the supply current is larger than the reference current and smaller than the overdrive current, into a diode-connected transistor of the bypass current mirror 121. To be more specific, a terminal of a diode connected transistor of the third current mirror 139 is connected to a second node 134, whereas a terminal of the other transistor of the third current mirror 139 is connected to the diode-connected transistor of the bypass current mirror 121. The second node 134 is coupled to the overdrive current source 135 and further to a non-diode-connected transistor of a second current mirror 126. A diode-connected transistor of the second current mirror 126 is coupled to the first node 124 acting as the comparator 114. The first node 124 is connected to an output of the variable transistor 123 and the reference current generator 116ᵢ as has also been explained above with reference to FIG. 2A. The second current mirror may comprise NMOS transistors.

For example, if the overdrive current equals I_{led}/K and there is a unity gain for the third current mirror 139, the driving circuit 100 may be operated as follows: When the supply voltage is low and the supply current is less than the reference current, no o current flows across the second current mirror 126. The overdrive current which is supplied by the overdrive current source 135 is fully supplied to the bypass current mirror 121 so that the entire current I_{led} is bypassed via the bypass current mirror 121 and no current flows into the LED 108ᵢ. When the supply voltage increases, the situation does not change until the supply current is larger than the reference current. In this case, current Iₙ, i.e. the difference between the supply current and the reference current, is mirrored by the second current mirror 126 to the second node 134. At the second node 134, the current Iₙ is subtracted from the overdrive current so that a current K×Iₙ starts flowing into the LED 108ᵢ, until the full conduction I_{led} is reached. At this point, the third mirror 139 is totally turned off. As a result, a more linear I/V characteristics of the corresponding LED 108ᵢ may be achieved, as will be explained below with reference to FIG. 4.

A difference between the functionality of embodiments illustrated in FIGS. 2A and 2B may be noticed, when the supply current equals Iref. According to embodiments illustrated in FIG. 2A, the bypass element 120 is totally off and the associated LED reaches the full conduction I_{led}. According to embodiments shown in FIG. 2B, on the contrary, the bypass element just starts reducing its current. Therefore, in case the current supplied by the overdrive voltage source 135 equals I_{led}/K, the associated LED starts being turned on.

As is clearly to be understood, the elements of FIG. 2B may be applied to the configuration of FIG. 1. In more detail, the single elements implementing the control element 112 may be assigned to each of the single LEDs 108ᵢ. Moreover, one single converter 118 may be assigned to the entire driving circuit 100. For example, the values of N and the reference voltage supplied by the reference current generator 116ᵢ may be set individually for each of the LEDs 108ᵢ.

According to implementations, due to offset and mismatch, the overdrive current should be larger than the I_{led}/K. Otherwise there is a risk that a small current is always present in the LED 108ᵢ. For example, the circuit may be designed to reduce the amount of safety margin taken.

FIG. 2C is an equivalent circuit diagram of the driving circuit 100 according to further embodiments. In addition to elements illustrated in FIG. 2B, the equivalent circuit diagram of FIG. 2C comprises a boosting circuit 138. For example, the boosting circuit 138 may comprise a first boosting current source 136 and a second boosting current source 137. For example, the first boosting current source 136 may be arranged between the second node 134 and the third current mirror 139. The second boosting current source 137 may be arranged between the first node 124 and the second current mirror 126. The first and the second boosting current sources 136, 137 may be matched or identical.

When the supply voltage is very small, in particular, below the voltage which determines the LED transition, the second current mirror 126 is totally off. In this case, the current provided by the first boosting current source 136 is added to the overdrive current generated by the overdrive current source 135. As a consequence, the on-resistance of the corresponding LED 108ᵢ is smaller. When the supply voltage and hence the supply current increases, the second current mirror 126 is turned on. As a result, the current at the second node 134 decreases since the current replicated by the second current mirror is subtracted from the overdrive current. Since the dynamic range across the LED string 15 tracks the supply voltage, this parameter is not significantly frustrated if the drop across a bypass element 120 increases as well.

At further higher supply voltages, the current across the second current mirror 126 becomes larger than the current provided by the first or second boosting current source. As a result, the effects of the two added boosting currents generated by the first and second boosting current sources 136, 137 cancel each other. As a result, the behavior of the bypass current mirror 121 does not change with respect to e.g. FIG. 2B.

Due to this configuration, the performance may be made more similar to a driving circuit comprising voltage comparators, especially if the transition threshold is large. Further, any clamping circuitry may be eliminated which may be necessary to limit the gate-to-source voltage of a bypass element 120. Accordingly, the bypass element 120 may be implemented in a more compact manner having a reduced size.

As is clearly to be understood, the elements of FIG. 2C may be applied to the configuration of FIG. 1. In more detail, the single elements implementing the control element 112 may be assigned to each of the single LEDS 108ᵢ. Moreover, one single converter 118 may be assigned to the entire driving circuit 100. For example, the values of N and the reference voltage supplied by the reference current generator 116ᵢ may be set individually for each of the LEDs 108ᵢ.

According to all embodiments described herein, the transition zone, e.g. the determination of the range of the supply voltage which is necessary to fully complete the transition may be set, e.g. by setting the size of a mirror, in more detail the gain N of the variable transistor 123.

FIG. 2D shows an equivalent circuit diagram of components of a driving circuit 100 according to still further embodiments. The equivalent circuit diagram of FIG. 2D is similar to the equivalent circuit diagram of FIG. 2C. As is further shown in addition, the gain S of the second current mirror 126 may be set. By setting a value of S, the slope of the I/V characteristics may be set, i.e. the sensitivity to a supply voltage.

According to a further interpretation, a driving circuit 100 for driving a light-emitting diode, LED, string 15 comprises a current comparator 114 and a bypass element 120. The current comparator 114 is configured to compare a supply current dependent on a supply voltage supplied by a voltage source 10 with a reference current, and to generate a difference current. The driving circuit 100 further comprises circuit elements for mirroring the difference current to the bypass element 120. The bypass element 120 is configured to subtract a bypass current depending on the difference current from an LED current fed to a corresponding one of the further LEDs 108ᵢ, the LED current depending on the supply current. For example, the driving circuit may further comprise a converter 118 to generate the supply current as a function of the supply voltage. For example, the bypass element 120 may be controlled so that, if the supply current is larger than the reference current, an LED current I_{led} is steered across the LED 108ᵢ and if the supply current is smaller than the reference current, a current smaller than I_{led} is steered across the LED.

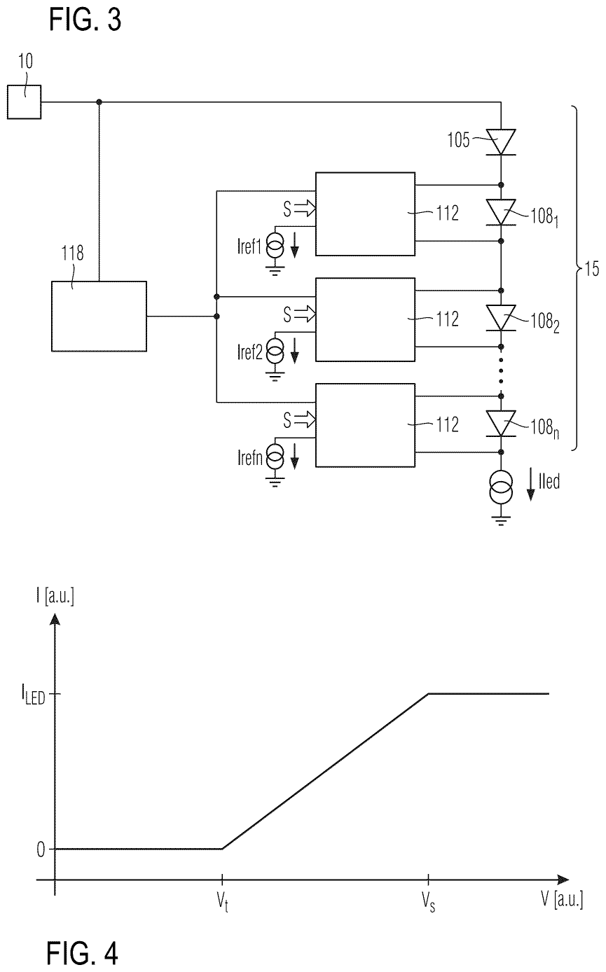

FIG. 3 shows an implementation of a driving circuit 100 for driving the LED string 15. As is shown in a similar manner, as has been discussed above with reference to FIG. 1, the LED string 15 comprises further LEDS 108₁, 108₂ . . . 108ₙ. Control elements 112 are connected to each of the further LEDS 108ᵢ. A value of S and a corresponding reference current I_{ref} may be set for each of the control elements, e.g. using a digital command. The set of control elements 112 is connected to the converter 118 which is configured to generate a supply current in dependence from a supply voltage supplied by the voltage source 10. Accordingly, the driving circuit comprises individual control elements 112 for each of the further LEDS 108ᵢ which may be set by setting a value of N, a value of S and the reference current. Moreover, the control elements 112 share a common converter 118.

FIG. 4 shows an example of an I/V characteristics of a single light emitting diode 108ᵢ. As is shown by employing any of the driving circuits as illustrated above, the I/V characteristics may be made more linear between the threshold Vₜ and a saturation value Vₛ. Moreover, as has been explained above, by setting a value of S, the slope of the I/V characteristics may be individually set for each of the LEDs 108ᵢ. Further, by setting a value of N, the transition range between Vₛ and Vₜ may be set for each of the LEDs 108ᵢ.

As has been discussed above, a bypass current which is a function of the supply current is injected in parallel to the further LEDS. As a result, the I/V characteristics can be made linear in each stage of the transition. Further a smooth transition in the LED may be achieved. Moreover, parameters of the I/V characteristics may be easily set by setting a gain of current mirrors. In particular, for each of the further LEDS 108i, a turn-on point may be individually set. Due to the specific implementation of the driving circuit, a temperature dependence of the I/V characteristics may be reduced.

While embodiments of the invention have been described above, it is obvious that further embodiments may be implemented. For example, further embodiments may comprise any subcombination of features recited in the claims or any subcombination of elements described in the examples given above. Accordingly, this spirit and scope of the appended claims should not be limited to the description of the embodiments contained herein.

### LIST OF REFERENCES

10 voltage source
15 LED string
100 driving circuit
105 first LED
108₁, . . . 108ₙ LED
112 control element
113 generator transistor
114 current comparator
116, 116₁, . . . 116ₙ reference current generator
118 converter
120 bypass element
121 bypass current mirror
123 variable transistor
124 first node
125 first current mirror
126 second current mirror
127 resistor
129 amplifier
131 first resistor
132 second resistor
134 second node
135 overdrive current source
136 first boosting current source
137 second boosting current source
138 boosting circuit
139 third current mirror

1. A driving circuit for driving a light-emitting diode, LED, string comprising a first LED and plurality of further LEDs coupled in series, the driving circuit comprising:
a current comparator, the current comparator being configured to compare a supply current dependent on a supply voltage supplied by a voltage source with a reference current, and to generate a difference current; and
a control element for controlling a current steered into one of the further LEDs,
the control element comprising a bypass element coupled in parallel to the further LED, the bypass element being controlled in dependence from the difference current.

2. The driving circuit according to claim 1, further comprising a converter to generate the supply current as a function of the supply voltage.

3. The driving circuit according to claim 1, wherein the control element comprises a variable transistor having a variable gain, the variable transistor being configured to deliver an adjustable supply current.

4. The driving circuit according to claim 1, wherein the control element is configured to control the bypass element so that if the supply current is larger than the reference current, an LED current I_{led} is steered across the LED and if the supply current is smaller than the reference current, a current smaller than I_{led} is steered across the LED, the LED current I_{led} depending on the supply current.

5. The driving circuit according to claim 1, wherein the control element comprises a current mirror configured to replicate the difference current of the reference current and the supply current into a diode-connected transistor of a bypass current mirror when the supply current is smaller than the reference current.

6. The driving circuit according to claim 5, wherein the control element comprises an overdrive current source configured to provide an overdrive current to the diode-connected transistor of the bypass current mirror when the supply current is smaller than the reference current.

7. The driving circuit according to claim 6, wherein the current mirror is configured to replicate the difference current to a third node connected to the overdrive current source and the control element comprises a further current mirror configured to replicate a further difference current, at a second node, of the overdrive current supplied and the difference current into the diode-connected transistor of the bypass current mirror, when the supply current is larger than the reference current and smaller than the overdrive current.

8. The driving circuit according to claim 6, further comprising a boosting circuit configured to add a boosting current to the further difference current at a second node, when the supply current is smaller than the reference current.

9. The driving circuit according to claim 7, wherein a gain of the current mirror is adjustable.

10. The driving circuit according to claim 1, further comprising further control elements, each of the further control elements being assigned to a corresponding one of the further LEDs.

11. The driving circuit according to claim 10, wherein the control elements are individually adjustable.

12. The driving circuit according to claim 10, wherein each of the control elements comprises a variable transistor having a variable gain, the gain of the variable transistors of the respective control elements being individually adjustable.

13. The driving circuit according to claim 10, wherein each of the control elements comprises a current mirror having a variable gain, the gain of the current mirrors of the control elements being individually adjustable.

14. A driving circuit for driving a light-emitting diode, LED, string comprising a first LED and plurality of further LEDs coupled in series, the circuit comprising:
a current comparator, the current comparator being configured to compare a supply current dependent on a supply voltage supplied by a voltage source with a reference current, and to generate a difference current;
a bypass element, and
circuit elements for mirroring the difference current to the bypass element,
the bypass element being configured to subtract a bypass current depending on the difference current from an LED current I_{led} fed to a corresponding one of the further LEDs, the LED current I_{led} depending on the supply current.

15. The driving circuit according to claim 14, wherein the bypass element is controlled so that, if the supply current is larger than the reference current, the LED current I_{led} is steered across the corresponding one of the further LEDs and if the supply current is smaller than the reference current, a current smaller than I_{led} is steered across the further LED, the LED current I_{led} depending on the supply current.

16. The driving circuit according to claim 1, wherein the bypass element comprises a bypass current mirror.

17. The driving circuit according to claim 1, wherein the control element comprises a first current mirror configured to replicate the difference current of the reference current and the supply current to a node connected to a bypass current mirror when the supply current is smaller than the reference current.
